(19) United States
(12) Patent Application Publication
(10) Pub. No.: US 2025/0013719 A1
(43) Pub. Date: Jan. 9, 2025

(54) Method for Processing a Variance of a Gaussian Process Prediction of an Embedded System

(71) Applicant: Robert Bosch GmbH, Stuttgart (DE)

(72) Inventors: Barbara Rakitsch, Stuttgart (DE); Volker Imhof, Kornwestheim (DE)

(21) Appl. No.: 18/751,493

(22) Filed: Jun. 24, 2024

(30) Foreign Application Priority Data
Jul. 3, 2023 (DE) 10 2023 206 290.9

(51) Int. Cl. G06F 17/18

(52) U.S. Cl. CPC G06F 17/18

(57) ABSTRACT

A method for processing a variance of a Gaussian process prediction of an embedded system is disclosed. A computer program, a device and a storage medium for this purpose is also disclosed.

This application claims priority under 35 U.S.C. § 119 to patent application no. DE 10 2023 206 290.9, filed on Jul. 3, 2023 in Germany, the disclosure of which is incorporated herein by reference in its entirety.

The disclosure relates to a method for processing a variance of a Gaussian process prediction of an embedded system. The disclosure also relates to a computer program, a device and a storage medium for this purpose.

### BACKGROUND

Embedded systems find application in a variety of technical environments. For example, embedded systems are also provided in vehicles to perform various monitoring, control or regulation functions. Further, calculations or predictions are also performed by embedded systems using models such as the Gaussian process, which can be based on sensor data of the vehicle.

Gaussian processes (GP) can in particular be used as a probabilistic method for non-parametric regression. In embedded systems, for example, in the prior art, there are specific hardware accelerators that allow the expected value of a Gaussian process prediction to be efficiently calculated.

The calculation and the memory requirement of the prediction scale in particular with O(M), wherein M is the number of support points. The number of support points can be a hyperparameter and can be freely selected for the application, wherein the number of support points can affect the accuracy of the approximation. The support points are in particular in a same space as the data inputs used. There are further also, for example, approaches in which the support points are in another space.

For the exact calculation of the variance of the prediction, the memory and run-time requirement can be in O(M²) and therefore, the calculation of which is not supported by instantaneous hardware accelerators. Standard algorithms for calculating the variance of the GP prediction scale in particular with O(M²) and are therefore not suitable for embedded systems. For example, there are applications that require a prediction of uncertainty. One example of this is safety-critical applications. To this end, a second model, a so-called watch dog, is often trained to decide whether the AI model is trustworthy. However, this can lead to problems if the GP and the watch dog estimate the uncertainty differently. Therefore, it can be better to use the GP variance directly.

In the article ELENKOV, Martin [et al.]: Estimation Methods for Viscosity, Flow Rate and Pressure from Pump-motor Assembly Parameters. In: Sensors, vol. 20, 2020, p. 1451, estimation methods for blood flow rate, pressure difference and viscosity are described using Gaussian process regression models.

### SUMMARY

The subject matter of the disclosure is a method, a computer program, a device, and a computer-readable storage medium having the features set forth below. Further features and details of the disclosure will emerge from the following description and the drawings. Features and details which are described in connection with the method according to the disclosure naturally also apply in connection with the computer program according to the disclosure, the device according to the disclosure and the computer-readable storage medium according to the disclosure, and vice versa in each case, so that reference is or can always be made to the individual aspects of the disclosure with respect to the disclosure.

The subject matter of the disclosure is in particular a method for processing a variance of a Gaussian process prediction of an embedded system, comprising the steps of:
providing sensor data of the embedded system,
performing the Gaussian process prediction, wherein an expected value for a target variable is determined based on the sensor data,
determining at least one sample, preferably at least one Monte-Carlo sample, based on the sensor data to determine a variance for the determined expected value using the at least one sample,
classifying the Gaussian process prediction based on an analysis of the determined variance, wherein at least one class of the classification classifies an accuracy and/or inaccuracy of the Gaussian process prediction and preferably classifying the Gaussian process prediction as inaccurate,
initiating an action as a function of the classification of the Gaussian process prediction.

In particular, an embedded system can be a computer or microcomputer, for example, in a vehicle, which is integrated in a technical context. The computer or microcomputer can, for example, perform monitoring, control or regulation functions or can be responsible for a form of data or signal processing. A Gaussian process prediction preferably relates to estimating or predicting the value of a function or process at one or more unobserved points based on the support points present. A Gaussian process is in particular a probabilistic model used to estimate functions. The Gaussian process models a function as a distribution over possible functions, and can advantageously provide both an estimate of the function history and information concerning the uncertainty of the estimate. Monte Carlo samples are in particular a type of sample used in the Monte Carlo simulation. The Monte Carlo simulation is preferably a method that uses random numbers to generate numerical results and solve complex problems that can be difficult or impossible to solve. In the context of the present disclosure, Monte Carlo samples can be examples of functions drawn from the Gaussian process. Each sample can represent a possible function that could explain the given data. By drawing and analyzing many of these samples, it is advantageous to gain an understanding of which functions are likely, or more targeted, and which are not. The method can advantageously evaluate whether the Gaussian process prediction is trustworthy or not, which is preferably expressed as inaccurate by the classification. In addition, by using the sample, the computational effort required for this purpose can be advantageously reduced.

It is also conceivable that the sensor data results from a measurement of at least one virtual sensor, wherein the target variable is a measured variable predicted by the Gaussian process prediction based on the sensor data. Virtual or indirect sensors are preferably software functions that cannot be used to derive or estimate variables that are difficult or impossible to measure from other measurable or available sensor data and information. A virtual sensor is thus in particular not a real sensor, but rather a dependency simulation of representative measured variables to a target variable. Alternatively, the sensor data can also result from a measurement of a real sensor.

The Gaussian process prediction can be performed using a variety of initial functions. The initial functions can be so-called prior functions, which reflect the initial knowledge or assumptions about the functions before evidence-based updates are made by the observed data.

The method can further comprise the following steps:
providing support points in the sensor data,
drawing functional values of the support points,
selecting a function from the plurality of initial functions,
determining a deviation between the function values of the support points and a result of an application of the selected function to provide a correction term for the selected function based on the deviation,
performing the Gaussian process prediction using the correction term and the selected function.

The support points can be data points in the sensor data used to predict the Gaussian process. The support points are in particular in a same space as the sensor data, but need not be selected from the amount of the data points in the sensor data. There are also, for example, approaches in which the support points are in another space. The number of support points can vary depending on the application. More support points can allow for a more accurate estimate, but also require more computing power. Fewer support points can lead to a smoother prediction, but can also capture less detail.

The preceding steps can be performed for each of the at least one sample. Furthermore, the step of performing the Gaussian process prediction can be performed by the embedded system and the remaining steps are performed by an external data processing device. By dividing the steps, the necessary computing power of the embedded system can be advantageously reduced.

According to an advantageous further development of the disclosure, it can be provided that, in the context of the analysis, an exceedance of a defined threshold value of the variance is assessed, wherein the exceedance of the defined threshold value is specific for an interpolation or an extrapolation, wherein in the presence of extrapolation, the Gaussian process prediction is classified as inaccurate. By detecting whether there is an interpolation or an extrapolation, it can be determined, for example, in a simplified manner, whether the sensor data is close to the training data with which the Gaussian process prediction was trained. Accordingly, if the sensor data is remote from the training data, it is particularly likely that the Gaussian process prediction is unreliable or inaccurate.

Preferably it can be provided that the action comprises at least one of the steps of:
discarding the Gaussian process prediction,
triggering an alarm to notify a user that the Gaussian prediction is classified as inaccurate.

For example, if the Gaussian process prediction is discarded, a new measurement of sensor data can be triggered or a substitute model can be used. For example, the alarm can be intended for a driver of a vehicle, so that the driver can take action or visit a repair or service center.

It is also conceivable that performing the Gaussian process prediction further comprises the step of:
performing an approximation by a linear model to reduce, by approximation, a computational effort for determining the variance for the expected value.

The Gaussian process function of the Gaussian process prediction can be

$$f ( \cdot ) = {\sum }_{l = 1}^{L} {w}_{l} {ϕ ( \cdot )}_{l} , w ∈ N ( 0 , 1 )$$

approached, or approximated, by the linear model. This interpretation allows in particular an approximate solution for a corresponding expected value and variance prediction to be efficiently determined.

Furthermore it is conceivable that the Gaussian process prediction is performed using a machine learning model, wherein the machine learning model is based on training comprising the steps of:
providing training data, wherein the training data represents sensor data resulting from a measurement of at least one sensor,
providing support points in the training data to provide reference points for training the machine learning model,
training the machine learning model, wherein the machine learning model is trained such that the machine learning model determines a function to determine the expected value of the target variable based on the training data.

Preferably, in the context of the disclosure, it can be provided that the method is applied to a vehicle or robot or technical system, wherein the embedded system is arranged in the vehicle or robot or technical system. The vehicle can, for example, be designed as a motor vehicle and/or a passenger vehicle and/or an autonomous vehicle. The vehicle can comprise a vehicle device, e.g., for providing an autonomous driving function and/or a driver assistance system. The vehicle device can be designed to control and/or accelerate and/or brake and/or steer the vehicle, at least partially automatically.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

Further advantages, features and details of the disclosure will emerge from the following description, in which embodiment examples of the disclosure are described in detail with reference to the drawings. The features mentioned in the claims and in the description can each be essential to the disclosure individually or in any combination.

### BRIEF DESCRIPTION OF THE DRAWINGS

FIG. 1 is a schematic visualization of a method, a device, a storage medium, and a computer program according to embodiment examples of the disclosure,

FIG. 2 is a schematic illustration of a vehicle, an embedded system, and a sensor according to embodiment examples of the disclosure.

### DETAILED DESCRIPTION

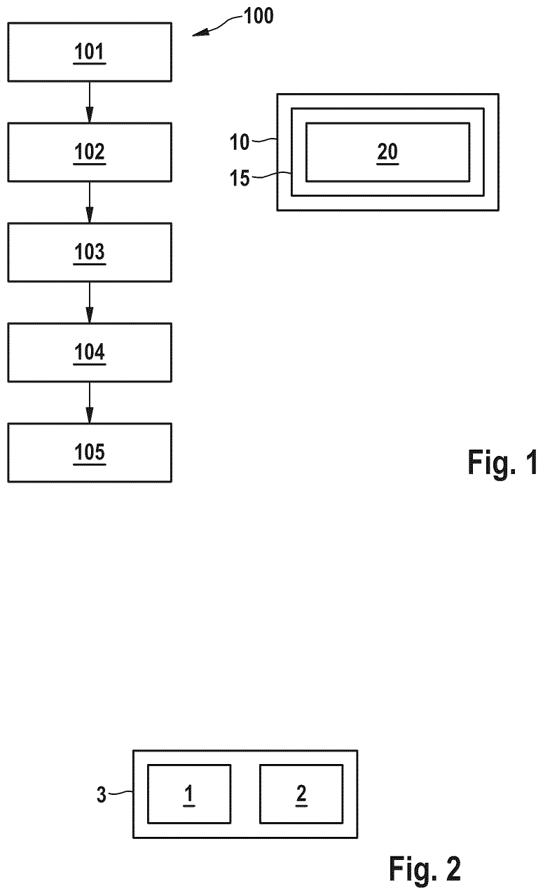

FIG. 1 schematically illustrates a method 100, a device 10, a storage medium 15 and a computer program 20 according to embodiment examples of the disclosure.

In a first step 101 of the method 100 according to an embodiment example, sensor data of the embedded system 1 is provided. In a second step 102 of the embodiment example, the Gaussian process prediction is performed, wherein an expected value for a target variable is determined based on the sensor data. In a third step 103, at least one sample is determined based on the sensor data in order to determine a variance for the expected value using the at least one sample. The sample is preferably a Monte Carlo sample. In a fourth step 104, the Gaussian process prediction is classified based on an analysis of the determined variance, wherein at least one class of classification classifies the Gaussian process prediction as inaccurate. In a fifth step 105, an action is initiated as a function of the classification of the Gaussian process prediction.

FIG. 2 schematically shows a vehicle 3, an embedded system 1, and a sensor 2. The embedded system 1 is in one embodiment arranged in the vehicle 3 and is preferably connected to the sensor 2. Sensor 2 can be a virtual sensor 2.

One aspect of this disclosure relates in particular to an algorithm for embedded systems that calculates the variance of a Gaussian process (GP) in O(M). For example, the algorithm is known from the work in [1], wherein the references are listed in square brackets at the end of the present description. One aspect of the present disclosure is in particular the implementation of the algorithm on an embedded system.

As mentioned above, one aspect of the present disclosure is to calculate the variance of a GP prediction with a computational and memory requirement of O(M). This preferably allows for the simple application of GP models for safety-critical applications in embedded systems. Thus, advantageously, if the variance prediction is too high, the system can react appropriately.

The exact computational and memory requirement for variance prediction is in particular O(M²). In the following, an approximate method is described, which can calculate the variance from Monte Carlo samples. Drawing a Monte Carlo sample can advantageously scale with O(M).

For the use of a possible method of the disclosure, there can be two target systems. A first system, which can efficiently calculate the mean, or expected value, of a GP prediction as a black box function, and a second system, which can perform a set of suitable basic operations in a freely selectable order.

The calculation of variance can advantageously allow a statement to be made as to whether the GP is acting in interpolation (near the training data) or in extrapolation (outside the training data). In the second case, a response can be triggered because the prediction is determined to be no longer trustworthy.

Often, for example, in the prior art, a watch dog is used to determine whether the GP is in interpolation or extrapolation. However, this can be problematic because the mean prediction and the variance prediction are decoupled. This can cause the following issues: For example, the watch dog is already in extrapolation, while the GP is still in interpolation, which triggers a response too early and can trigger a false alarm. In another case, the watch dog is still in interpolation, while the GP is already in extrapolation, which uses an untrusted prediction and can in turn create a security risk.

In particular, the disclosure shows how an algorithm for determining the variance of the GPs [1] can be calculated in embedded systems. An appropriate response can thus be triggered if the uncertainty of the prediction is too great.

The disclosure is in particular relevant in the context of “virtual sensors” when the output of the GPs is used for regulation, control or monitoring applications (for example on-board diagnostics).

In an embodiment example of the present disclosure, the following set-up can be assumed: Given a training dataDₜᵣₐᵢₙ=(xₙ, yₙ)ₙ₌₁^{N}, wherein xₙ∈ [symbol] ^{D}^{ₓ} is the input and yₙ∈ [symbol] is the output of the nth sample. One objective is preferably to learn a function ƒ: [symbol] ^{D}^{ₓ}→ [symbol] that associates an input xₙ to an output yₙ. A probabilistic setting can further be assumed in which the function ƒ˜GP(0, k) has a GP prior with zero mean. The core function is preferably given by k: [symbol] ^{D}^{ₓ}× [symbol] ^{D}^{ₓ}→ [symbol] . The support points are in particular characterized by X_{ind}=(xₘ)ₘ₌₁^{M} and their probabilistic outputs Y_{ind}˜N(μ_{ind}, Σ_{ind}), wherein μ_{ind}∈ [symbol] ^{M}, Σ_{ind}∈ [symbol] ^{M×M}. the number of support points M can be a hyperparameter and can be freely selected by the user. It can be a goal of the algorithm to efficiently determine the mean E[y_{*}] and variance Var[y_{*}] of the GP prediction for a new input x_{*}.

Standard prediction: The standard formulas of the sparse GP prediction are according to [2]:

$$E [ {y}_{*} ] = K ( {x}_{*} , {X}_{ind} ) α ,$$

$$Var [ {y}_{*} ] = K ( {x}_{*} , {x}_{*} ) - K ( {x}_{*} , {X}_{ind} ) Ω ( {X}_{ind} , {x}_{*} ) ,$$

wherein α=K(X_{ind}, X_{ind})⁻¹μ_{ind} and Ω=K(X_{ind}, X_{ind})⁻¹(K(X_{ind}, X_{ind})+Σ_{ind})K(X_{ind}, X_{ind})⁻¹. The terms α and Ω can be precalculated because they are not dependent on the test point x_{*}. After caching, the memory and run-time complexity to calculate E[y_{*}] or Var[y_{*}] are O(M) and O(M²) respectively. This can be one reason why instant hardware accelerators only provide the mean prediction as a function. The variance prediction can cost too many resources.

Interpretation as linear regression: With the Kernel Trick according to [3], the core function k( [symbol] ) can be represented as the inner product in a repeating Kernel-Hilbert space (RKHS) H

k(x,x′)= [symbol] ψ(x),ψ(x′) [symbol] _{H},
wherein ψ: [symbol] ^{D}^{ₓ}→H can be a mapping into a (potentially infinitely large) feature space. For many core functions, the inner product can be further

[symbol]

ψ(x),ψ(x′) [symbol] _{H}≈ϕ(x)^{T}ϕ(x′)
approximated, wherein ψ: [symbol] ^{D}^{ₓ}→ [symbol] ^{D}^{_{L}} is preferably a finite mapping. This is possible, for example, for all stationary cores, in particular for the RBF core.

The GP function can then be

$$f ( \cdot ) = {\sum }_{l = 1}^{L} {w}_{l} {ϕ ( \cdot )}_{l} , w ∈ N ( 0 , 1 )$$

approached by the linear model. This interpretation of the GP allows in particular an approximate solution for the mean and variance prediction to be efficiently determined. Preferably, the a-posteriori distribution p(w|Dₜᵣₐᵢₙ) is first calculated in order to then determine the predictive probability p(y_{*}|x_{*})=∫p(y_{*}|w, x_{*})p(w|Dₜᵣₐᵢₙ)dw.

The approximation quality can be dependent on the size N of the training data set Dₜᵣₐᵢₙ as follows: The larger the data set, the worse the approximation works.

In particular, the following shows how Matheron's Rule can be used to efficiently calculate the mean and the variance of a GP prediction [1].

Matheron's Rule states in particular that instead of drawing a sample directly from the posterior, a sample can also be drawn from the prior and then appropriately corrected:

$${y}_{*} \vert {y}_{ind} = {f}_{prior} ( {x}_{*} ) + k ( {x}_{*} , {X}_{ind} ) {K ( {X}_{ind} , {X}_{ind} )}^{- 1} ( {y}_{ind} - {f}_{prior} ( {X}_{ind} ) ) ,$$

wherein y_{ind}˜N(y_{ind}, Σ_{ind}) and ƒₚᵣᵢₒᵣ˜GP(0, k( [symbol] )).

Thus a Monte Carlo sample can be generated from the GP posterior as follows:
1. First, the support points can be drawn: y_{ind}˜N(μ_{ind}, Σ_{ind}),
2. A function can then be drawn from the prior: ƒₚᵣᵢₒᵣ˜GP(0, k( [symbol] )),
3. Accordingly, β=K(X_{ind}, X_{ind})⁻¹(y_{ind}−ƒₚᵣᵢₒᵣ(X_{ind})) can be determined.
4. For the test point x_{*}, the Monte Carlo prediction can then be calculated: y_{*}=ƒₚᵣᵢₒᵣ (x_{*})+k(x_{*}, X_{ind})β

By drawing S Monte Carlo samples, the variance of the GP prediction can be determined.

This calculation can be advantageous in terms of several aspects: Steps 1-3 need in particular only be calculated once (offline). Preferably, the only step that needs to be calculated in the embedded system is step 4.

Step 2 requires in particular a function to be drawn from the GP prior. This can only be possible to a limited extent if the standard GP formulas are used. However, it is preferably straightforward to approximate the Gaussian process as linear regression, as already explained above: After the weights w and feature mapping ϕ have been drawn, the function ƒ(⋅)=Σₗ₌₁^{L}wₗϕ(⋅)ₗ can be evaluated at any input in O(L). Step 4 preferably consists of the two Prior and Correction Term parts. The calculation specification for the correction term is in particular identical to the standard mean prediction and scaled in O(M). Specific hardware accelerators can be used for this calculation.

In the following, an embodiment example shows how the algorithm can be used on an embedded system.

For example, in offline mode, the calculations below cannot be performed on the target hardware.

Inputs can be a kernel function: k(⋅, ⋅), inducing inputs: X_{ind}, a distribution over inducing outputs: y_{ind}˜N(μ_{ind}, Σ_{ind}) and a number of Monte Carlo samples are: S.

For example, a pseudo-code of the calculations is listed below:
FOR s=1, . . . S DO
Sample inducing outputs: y_{ind}^{(s)}˜N(μ_{ind}, Σ_{ind})
Sample a function from the prior: w^{(s)}˜N(0,1), ϕ^{(s)}˜p(ϕ)
Compute ƒₚᵣᵢₒᵣ^{(s)}(X_{ind})=Σwₗ^{(s)}ϕ^{(s)}(X_{ind})
Compute β^{(s)}=K(X_{ind}, X_{ind})⁻¹(y_{ind}^{(s)}−ƒₚᵣᵢₒᵣ^{(s)}(X_{ind}))
DONE

In the online mode, the calculations below can be performed on the target hardware.

Inputs can be a kernel function: k(⋅, ⋅), inducing inputs: X_{ind}, a test input, x_{*}a number of Monte Carlo samples: S, a mapping (ϕ^{(s)})ₛ₌₁^{S} and weights (w^{(s)})ₛ₌₁^{S}, (β^{(s)})ₛ₌₁^{S}.

According to an embodiment example, case 1 is an embedded system, which can calculate the mean, or expected value, of a GP prediction as a black-box function. In other words, there is in particular an embedded system, which only needs to be supplemented with the calculation of variance.

The calculation by an exemplary pseudo-code is described below:
FOR s=1, . . . , S DO
Compute ƒₚᵣᵢₒᵣ^{(s)}(x_{*})=Σwₗ^{(s)}ϕ^{(s)}(x_{*})
Compute k_{*}=k(x_{*}, X_{ind}) (on accelerated hardware)
Compute ƒ_{corr}^{(s)}(x_{*})=k(x_{*}, X_{ind})β^{(s)} (on accelerated hardware)
Compute y_{*}^{(s)}=ƒₚᵣᵢₒᵣ^{(s)}(x_{*})+ƒ_{corr}^{(s)}(x_{*})
DONE
Storage means: O(SL+MD+SM)
Duration: O(SL+SMD)

According to an embodiment example, case 2 is an embedded system which can perform a lot of suitable base operations in freely selectable order. In other words, there is in particular an embedded system that calculates or can calculate all calculations of the present disclosure itself.

The calculation by a pseudo-code is described below:
Compute k_{*}=k(x_{*}, X_{ind})
FOR s=1, . . . , S DO
Compute ƒₚᵣᵢₒᵣ^{(s)}(x_{*})=Σwₗ^{(s)}ϕ^{(s)}(x_{*})
Compute ƒ_{corr}^{(s)}(x_{*})=k_{*}β^{(s)}
Compute y_{*}^{(s)}=ƒₚᵣᵢₒᵣ^{(s)}(x_{*})+ƒ_{corr}^{(s)}(x_{*})
DONE
Storage means: O(SL+MD+SM)
Duration: O(SL+MD+SM)

In the context of the present disclosure, it is in particular assumed that a GP with a mean, or expected value, of zero mean is used: ƒ˜GP(0, k).

In possible further applications, a Gaussian process having a mean, or expected value, of non-zero mean can be used, for example, ƒ˜GP(m, k) wherein the mean function m(⋅): [symbol] ^{D}^{ₓ}→ [symbol] originates from domain knowledge.

The mean, or expected value, prediction can then be preferably calculated by the formula

$${y}_{*} = m ( {x}_{*} ) + k ( {x}_{*} , {X}_{ind} ) {K ( {X}_{ind} , {X}_{ind} )}^{- 1} ( {y}_{ind} - m ( {x}_{*} ) ) .$$

In hybrid modeling (combination of AI models and physical pre-knowledge), this type of model is also referred to as “delta model”: The GP can correct the prediction of the physical model. If the test input x_{*} is far from X_{ind}, k(x_{*}, X_{ind}) preferably goes to zero and takes over the physical model. At the same time, the variance of the prediction can increase.

It can be found that this formula is very similar to the Monte Carlo predictive formula listed above, wherein m(x_{*}) takes the role of ƒₚᵣᵢₒᵣ(x_{*}). This can allow the algorithm to be interpreted as a hybrid model with a stochastic physical model, wherein linear approximation of the GP prior assumes the role of the physical model.

The above explanation of the embodiments describes the present disclosure solely within the scope of examples. Of course, individual features of the embodiments can be freely combined with one another, if technically feasible, without leaving the scope of the present disclosure.
[1] Wilson, James, et al. “Efficiently sampling functions from Gaussian process posteriors.” International Conference on Machine Learning. 2020.
[2] Titsias, Michaelis. “Variational learning of inducing variables in sparse Gaussian processes” Artificial Intelligence and Statistics, 2009.
[3] Schölkopf Bernard, et al. “Learning with Kernels: Support Vector Machines, Regularization, Optimization and Beyond.” MIT press, 2001.

What is claimed is:

1. A method for processing a variance of a Gaussian process prediction of an embedded system, comprising:
providing sensor data of the embedded system,
performing the Gaussian process prediction, wherein an expected value for a target variable is determined based on the sensor data,
determining at least one sample based on the sensor data to determine a variance for the determined expected value using the at least one sample,
classifying the Gaussian process prediction based on an analysis of the determined variance, wherein at least one class of the classification classifies an inaccuracy of the Gaussian process prediction,
initiating an action as a function of the classification of the Gaussian process prediction,
wherein the Gaussian process prediction is performed using a plurality of initial functions, wherein the method further comprises:
providing support points in the sensor data,
drawing functional values of the support points,
selecting a function from the plurality of initial functions,
determining a deviation between the function values of the support points and a result of an application of the selected function to provide a correction term for the selected function based on the deviation,
performing the Gaussian process prediction using the correction term and the selected function,
wherein the preceding steps are performed for each of the at least one sample, and
wherein the step of performing the Gaussian process prediction is performed by the embedded system and the remaining steps are performed by an external data processing device.

2. The method according to claim 1, wherein:
the sensor data results from a measurement of at least one virtual sensor, and
the target variable is a measured variable predicted by the Gaussian process prediction based on the sensor data.

3. The method according to claim 1, wherein:
in the context of the analysis, an exceedance of a defined threshold value of the variance is assessed,
the exceedance of the defined threshold value is specific for an interpolation or an extrapolation, and
in the presence of extrapolation, the Gaussian process prediction is classified as inaccurate.

4. The method according to claim 1, wherein the action comprises at least one of:
discarding the Gaussian process prediction, and
triggering an alarm to notify a user that the Gaussian prediction is classified as inaccurate.

5. The method according to claim 1, wherein performing the Gaussian process prediction further comprises:
performing an approximation by a linear model to reduce, by approximation, a computational effort for determining the variance for the expected value.

6. The method according to claim 1, wherein the Gaussian process prediction is performed using a machine learning model, and wherein the machine learning model is based on training comprising:
providing training data, wherein the training data represents sensor data resulting from a measurement of at least one sensor,
providing support points in the training data to provide reference points for training the machine learning model, and
training the machine learning model, wherein the machine learning model is trained such that the machine learning model determines a function to determine the expected value of the target variable based on the training data.

7. The method according to claim 1, wherein:
the method is applied to a vehicle, and
the embedded system is arranged in the vehicle.

8. A computer program comprising instructions that, when the computer program is executed by a computer, cause the computer to carry out the method according to claim 1.

9. A device for data processing which is configured to carry out the method according to claim 1.

10. A computer-readable storage medium comprising instructions which, when executed by a computer, cause it to carry out the steps of the method according to claim 1.

11. The method according to claim 1, wherein the at least one sample is at least one Monte-Carlo sample.
